(19) United States
(12) Patent Application Publication
(10) Pub. No.: US 2007/0130144 A1
(43) Pub. Date: Jun. 7, 2007

(54) METHOD AND SYSTEM FOR CONCURRENT PROCESSING OF LIST ITEMS

(75) Inventor: ANDREW DAVID BANKS, Hampshire (GB)

Correspondence Address: IBM CORPORATION, 3039 CORNWALLIS RD., DEPT. T81 / B503, PO BOX 12195, REASEARCH TRIANGLE PARK, NC, 27709, US

(73) Assignee: INTERNATIONAL BUSINESS MACHINES CORPORATION, Armonk, NY (US)

(21) Appl. No.: 11/562,011

(22) Filed: Nov. 21, 2006

(30) Foreign Application Priority Data
Nov. 30, 2005 (GB) 0524348.0

(51) Int. Cl. G06F 17/30

(52) U.S. Cl. 707/8

(57) ABSTRACT

For concurrent processing of list items by multiple control threads, a list structure is provided in the form of a reference list referencing items by a sequence number and a plurality of sub-lists across which the items are distributed. The reference list is locked when allocating or retrieving a sequence number for an item, but only the sub-list in which an item is held is locked when a control thread adds or removes an item to or from the sub-list.

### FIELD OF THE INVENTION

The invention relates to the field of reliable ordered processing of data. In particular, it relates to concurrent processing of data by multiple processors whilst maintaining reliable ordered processing of the data.

### BACKGROUND

Ordered data in the form of a list of data items may be provided in a range of applications. The order of the items in the list must be maintained during processing of the items.

In a multiprocessor environment, multiple threads of control can process a list at the same time. However, a list may require locking during the item processing in order to maintain serial processing of the items of the list. Where multiprocessors are available to process the items, the locking can severely limit the throughput of the item processing.

In reliable messaging systems, a list of items may be provided in the form of a message queue. Messages must be placed on a queue in order and removed in the same order. This inevitably leads to having to lock the queue to insert the new message at the tail of the queue or to remove an existing message from the head or the queue. This locking serializes processing of messages on the queue, but limits the throughput of messaging systems. Where multiprocessor systems are used, the processing capacity may often not be fully utilized due to the queue locking.

In queues that are maintained under the scope of a transaction and logged to disk, the constructing of log records must be carried out with the list locked and this typically takes a relatively large amount of processing time. This further limits the processing throughput.

It is an aim of the present invention to provide a method and system which maintain the integrity of a list of items whilst permitting its concurrent use by multiple threads of control.

Although the multiple threads of control are described in a multiprocessor environment, it is possible that the multiple threads of control are provided in a single processor system.

The invention is described in detail in terms of messaging systems; however, it can be applied to other systems with a list of ordered items.

According to a first aspect of the present invention there is provided a method for concurrent processing of list items by multiple control threads, comprising: referencing items in a reference list by a sequence number; distributing the items across a plurality of sub-lists; locking the reference list when allocating or retrieving a sequence number for an item; and locking a sub-list when adding or removing an item to or from the sub-list.

Locking the reference list when allocating a sequence number for an item may include locking a tail sequence number of the reference list during allocation of a sequence number to a new item.

Locking the reference list when retrieving a sequence number may include locking a head sequence number of the reference list during determination of the sub-list in which an item is held and during searching for the item in the sub-list.

If the item is not found in the sub-list, the method may include searching all sub-lists for items with highest available sequence number.

The step of distributing may include applying a distribution algorithm based on the sequence number. The distribution algorithm may be deterministic and may distribute items evenly across the sub-lists. The step of determining the sub-list in which an item is held may use the distribution algorithm. The distribution algorithm may be a round robin distribution across the sub-lists.

According to a second aspect of the present invention there is provided a system for concurrent processing of list items by multiple control threads, comprising: multiple control threads contending for processing of items; a list structure including: a reference list referencing items by a sequence number; a plurality of sub-lists across which the items are distributed; a lock for the reference list when allocating or retrieving a sequence number for an item; and a lock for a sub-list when a control thread adds or removes an item to or from the sub-list.

The lock for the reference list when allocating a sequence number for an item may include a lock for a tail sequence number of the reference list during allocation of a sequence number to a new item.

The lock for the reference list when retrieving a sequence number may include a lock for a head sequence number of the reference list during determination of the sub-list in which an item is held and during searching for the item in the sub-list.

The system may be a multiprocessor system. The reference list and the sub-lists may be queue structures. The system may be a messaging system.

The system may be a reliable messaging system with a reference list and sub-lists in the form of queues and adding or removing an item puts or gets a message from the queues.

According to a third aspect of the present invention there is provided a list structure, comprising: a reference list referencing items by a sequence number; a plurality of sub-lists across which the items are distributed; a lock for the reference list when allocating or retrieving a sequence number for an item; and a lock for a sub-list when a control thread adds or removes an item to or from the sub-list.

According to a fourth aspect of the present invention there is provided a computer program product stored on a computer readable storage medium, comprising computer readable program code means for performing the steps of: referencing items in a reference list by a sequence number; distributing the items across a plurality of sub-lists; locking the reference list when allocating or retrieving a sequence number for an item; and locking a sub-list when adding or removing an item to or from the sub-list.

### BRIEF DESCRIPTION OF THE DRAWINGS

Embodiments of the present invention will now be described, by way of examples only, with reference to the accompanying drawings, in which:

FIG. 1 is a block diagram of a computer system in which multiple processors operate on a list of items in which the present invention may be applied;

FIG. 2 is a schematic diagram of a list structure in accordance with the present invention;

FIG. 3 is a schematic diagram of the allocation to sub-lists in accordance with a preferred embodiment of the present invention;

FIG. 4 is a block diagram of a messaging system in which a preferred embodiment of the present invention may be applied;

FIG. 5 is a flow diagram of a method of adding a message to a queue in accordance with a preferred embodiment of the present invention; and

FIG. 6 is a flow diagram of a method of removing a message from a queue in accordance with a preferred embodiment of the present invention.

### DETAILED DESCRIPTION

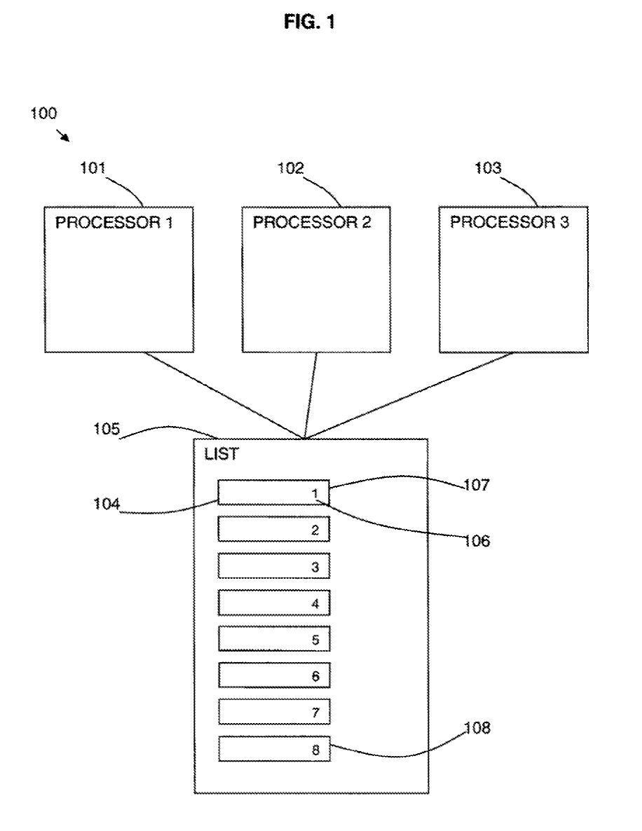

Referring to FIG. 1, a generalized representation of a computer system 100 is shown in which multiple processors 101, 102, 103 have access to and process items 104 on a list 105. The list 105 has an item at the head 107 of the list and an item at the tail 108 of the list. If the list has a single item, the head 107 and the tail 108 of the list 105 are the same item 104.

In an ordered list 105 the items 104 are placed on the list 105 and removed from the list 105 in the same order. To maintain the order of the items 104 on the list 105, each item 104 has a list sequence number 106 allocated when the item 104 is added to the list 105.

The multiple processors 101, 102, 103 may add items 104 to the tail 108 of the list and remove items 104 from the head 107 of the list. Removal of an item 104 from the list 105 may involve processing of the item 104 (for example, to record data changes, etc.). The processors' activities may happen concurrently and, in known systems, any conflict is avoided by locking the list 105 during the additional or removal of an item 104 and the associated processing by one of the processors 101, 102, 103.

In the described system, the list 104 is partitioned into multiple sub-lists which are provided alongside an overall reference list.

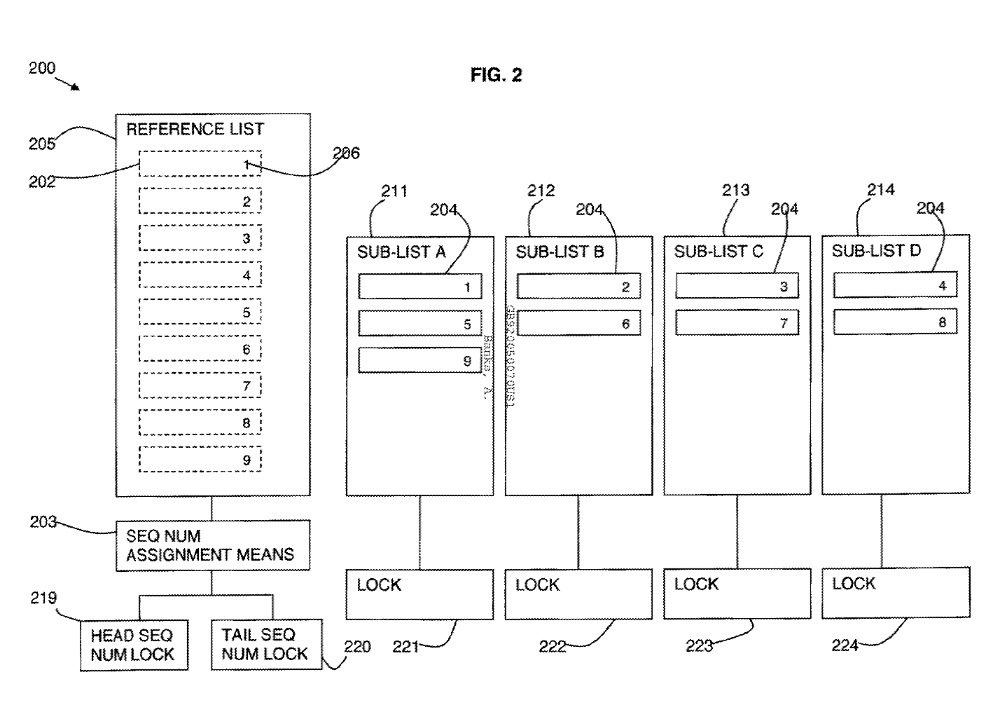

Referring to FIG. 2, a list structure 200 is provided with an overall reference list 205 and multiple sub-lists 211, 212, 213, 214. The reference list 205 provides a reference 202 to each item 204 with a sequence number 206.

Each item 204 is assigned a sequence number 206 when it is added to the list structure 200. The sequence number 206 determines the order of the items on the list 205. In order to assign the sequence number 206, the tail sequence number of the reference list 205 must be locked for the duration of the assignment of the sequence number 206, to ensure no contention for the sequence numbers.

When an item 204 is removed from the list structure 200, the head sequence number of the reference list 205 must be locked for the duration of the location of the item 204 to be processed and removed.

FIG. 2 shows a sequence number assignment means 203 and head and tail sequence number locking means 219, 220 associated with the reference list 205. A single locking means for the head and tail sequence numbers could be provided with more contention as a result. The time during which the reference list 205 is locked is kept as short as possible.

Sub-lists 211, 212, 213, 214 are provided and the items 204 referenced 202 in the reference list 205 are held in one of the sub-lists 211, 212, 213, 214. The processing of the items 204 is carried out on the sub-lists 211, 212, 213, 214 which can each be individually locked as required when an item 204 is being processed. Locks 221, 222, 223, 224 are provided for each of the sub-lists 211, 212, 213, 214.

In one embodiment, the sequence number 206 in the reference list 206 is used to determine in which sub-list 211, 212, 213, 214 an item is held. This may be achieved by the items 204 being distributed in a round robin distribution between the sub-lists 211, 212, 213, 214. The sequence numbers 206 should be allocated in a way that makes it easy to predict the next number, for example, by counting upwards.

Consequently, if there are four sub-lists 211, 212, 213, 214 as shown in FIG. 2, the first sub-list 211 holds items with sequence numbers 1, 5, 9, 13, 17, etc., the second sub-list 212 holds items with sequence numbers 2, 6, 10, 14, 18, etc., the third sub-list 213 holds items with sequence numbers 3, 7, 11, 15, 19, etc., and the fourth sub-list 214 holds items with sequence numbers 4, 8, 12, 16, 20, etc. In a distribution of items of this type, the sub-list 211, 212, 213, 214 in which an item 204 is held can be determined by dividing the sequence number by the number of sub-lists and the remainder is the number of the sub-list in which the item 204 is held.

The allocation of items 204 to the sub-lists 211, 212, 213, 214 may be by use of another form of algorithm as long as the identification of the sub-list is the same when adding an item and when removing the item.

The sequence number 206 of an item 204 being removed from the head of the reference list 205 and the sequence number of an item 204 being added to the tail of the reference list 205 are monitored and the reference 202 to the appropriate sequence number 206 is locked in the reference list 205 whilst the item 204 is added or removed.

The processor carrying out the operation on the item 204 does not need to be aware of the sub-lists 211, 212, 213, 214 and it may perceive the list structure 200 as the reference list 205, being unaware of the underlying sub-lists. In one scenario, the processors may be organized such that each processor may make exclusive use of a sub-list all of the time.

Each item 204 is assigned a sequence number 206 in the reference list 205, which involves taking a lock, but for a shorter time than is required to update the underlying list.

A significant advantage comes with removal of items 204 from the list structure 200. The sequence number 206 of the previous item 204 removed is known and is used to quickly predict which sub-list 211, 212, 213, 214 holds the next item 204. The head sequence number 206 in the reference list 205 while the item 204 is locked and the sub-list 211, 212, 213, 214 identified from which the item 204 is to be removed. The identified sub-list 211, 212, 213, 214 is locked briefly to mark the item to be removed. The sequence number 206 and the sub-list 211, 212, 213, 214 are then unlocked. The sub-list 211, 212, 213, 214 is locked again to remove the item 204 at a later time.

The described method enables partitioning the contention for the head and tail of the list structure and enables a fast, speculative prediction of which sub-list to lock when removing an item from the list structure.

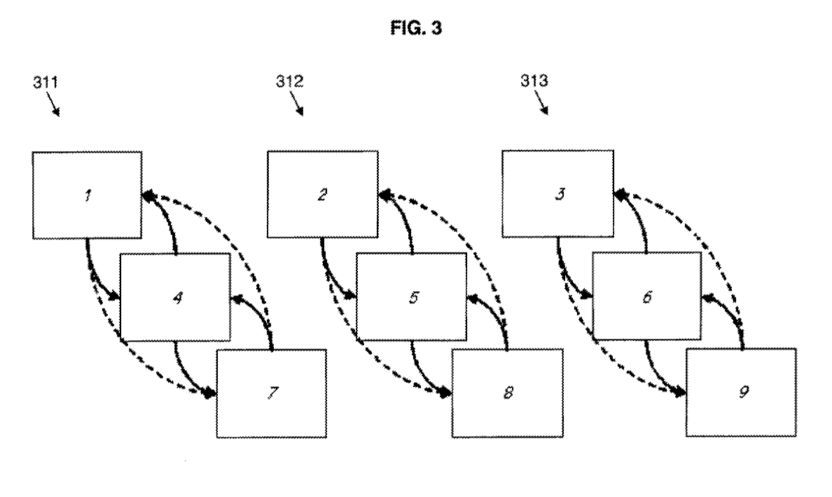

FIG. 3 shows items 304 distributed across three sub-lists 311, 312, 313. The solid arrows show the references between the items before removal and the dotted arrows show the references after removal of the middle item of each sub-list. This shows a doubly linked sub-list although many structures are equally applicable, for example, a singly linked sub-list, or an array sub-list.

An exemplary embodiment is described in the context of a messaging environment. An example of an ordered list of items is a queue of messages; however, there are variants of this such as the ordered set of publications waiting for a subscriber to process, and internal queues used to store such things as the expiry order of messages. The invention could equally be applied to other applications and environments with reliable ordered processing of data.

Messaging and queuing enables applications to communicate without having a private connection to link them. Applications communicate by putting messages on message queues and by taking messages from message queues. The communicating applications may be running on distributed computer systems.

In a reliable queuing system, messages are placed on a queue and removed from the queue in the same order. A number of message producers are each putting messages to the tail of the queue, whilst a number of message consumers are each getting messages from the head of the queue. In a multiprocessor environment, the message producers and message consumers can process messages in parallel by using a queue in the form of the described list structure. The queue is divided into sub-queues where the messages are held with a reference queue listing sequence numbers for the messages.

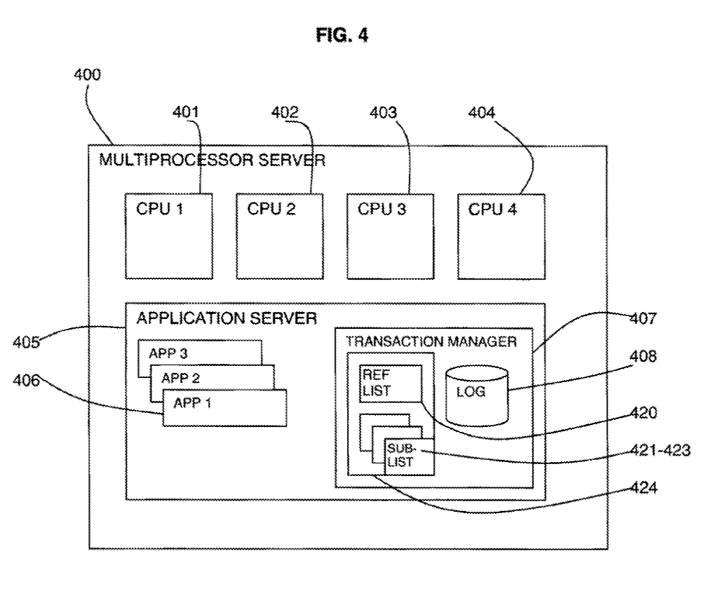

FIG. 4 shows an exemplary embodiment of an implementation of the described system and method. A multiprocessor server 400 is provided with four central processing units 401, 402, 403, 404 each of which can carry out processing work.

The server 400 includes application server middleware 405 which handles application logic and connections found in client-server applications 406. The application server 405 includes a transaction manager 407 with a transaction log 408. The application server 405 has an associated queue based message system which provides messaging queues.

Applications 406 use transactions to co-ordinate multiple updates to resources as one unit of work such that all or none of the updates are made permanent. The transaction manager 407 supports the co-ordination of resource managers to participate in distributed global transactions as well as local transaction support when local resources are used.

The transaction manager 407 stores information regarding the state of completing transactions in a persistent form that is used during transaction recovery. The persistent form is referred to as a transaction log 408. Lists are maintained under the scope of a transaction and logged to disk.

A transaction list structure 424 is provided made up of an overall reference transaction list 420 in the form of a queue with sub-queues 421, 422, 423 across which messages are distributed as described with reference to FIG. 2.

The described concurrent list scheme is particularly suited to situations where there is a lot of processing to be done to add or remove items from the list. In the embodiment of the transaction list 424, after the addition or removal of a message, the pointers for the new list structure must be computed. In addition, the data to be written to the transaction log to record this must be constructed. It is constructing the log records that makes this process hundreds or thousands of times longer than in the non-transactional case. It is not necessary to actually write the log record while the locks are held but all of the data must be captured which is needed to write and establish its order in the sequence of log records.

The locking of the sequence number is a synchronize block as implemented in Java™:

long localSequenceNumber;

synchronize (globalSequenceNumberLock) {

globalSequenceNumber++;
localSequenceNumber = globalSequenceNumber;

}

Java and all Java-based trademarks and logos are trademarks of Sun Microsystems, Inc in the United States, other countries, or both.

It has been demonstrated that in a queuing prototype a two way processor can be fully utilized without this technique, whereas with it four or more processors can be fully utilized in a multiprocessor system.

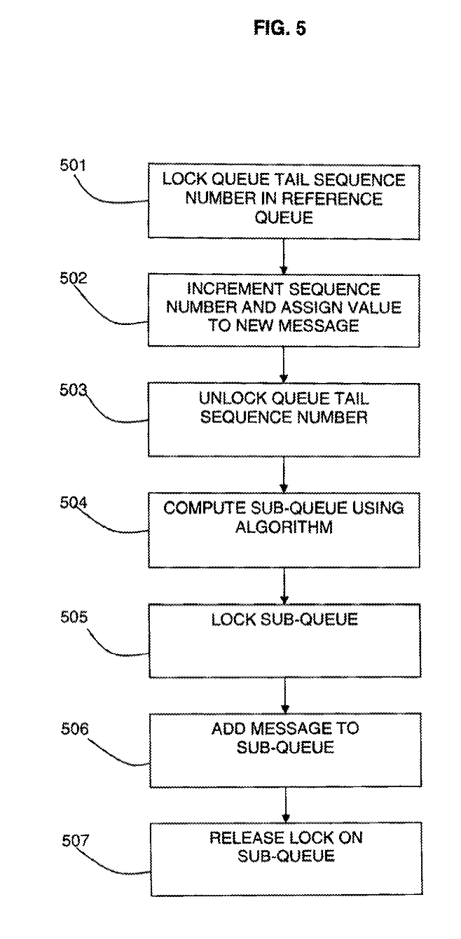

Referring to FIG. 5, a flow diagram shows the steps to add a message to the tail of a queue.

1) Lock the queue tail sequence number 501 in the reference queue.

2) Increment the sequence number and assign the new value to the new message 502. This determines the position of the message in the reference queue.

3) Unlock the queue tail sequence number 503 in the reference queue.

4) Compute the sub-queue to add the message to it using the sequence number generated above 504. For example, sublistIndex=sequenceNumber % numberOfSublists The algorithm used must be deterministic and should spread the messages evenly over the sub-queues.

5) Lock the sub-queue 505.

6) Add the message to the sub-queue 506. The messages are added to the sub-queue in sequence number order to speed their eventual removal. This has to account for another thread locking the sub-queue with a sequence number ahead of the one being added.

When adding to the sub-queue, it is advantageous, but not absolutely necessary to add the messages in the sub-queue so that they are stored in sequence number order. The advantage comes because removal of the messages generally takes longer than insertion if the whole sub-queue is searched to determine which is the next message. If the messages are stored in sequence number order this processing is faster because the search can be terminated sooner.

7) Release the lock on the sub-queue 507.

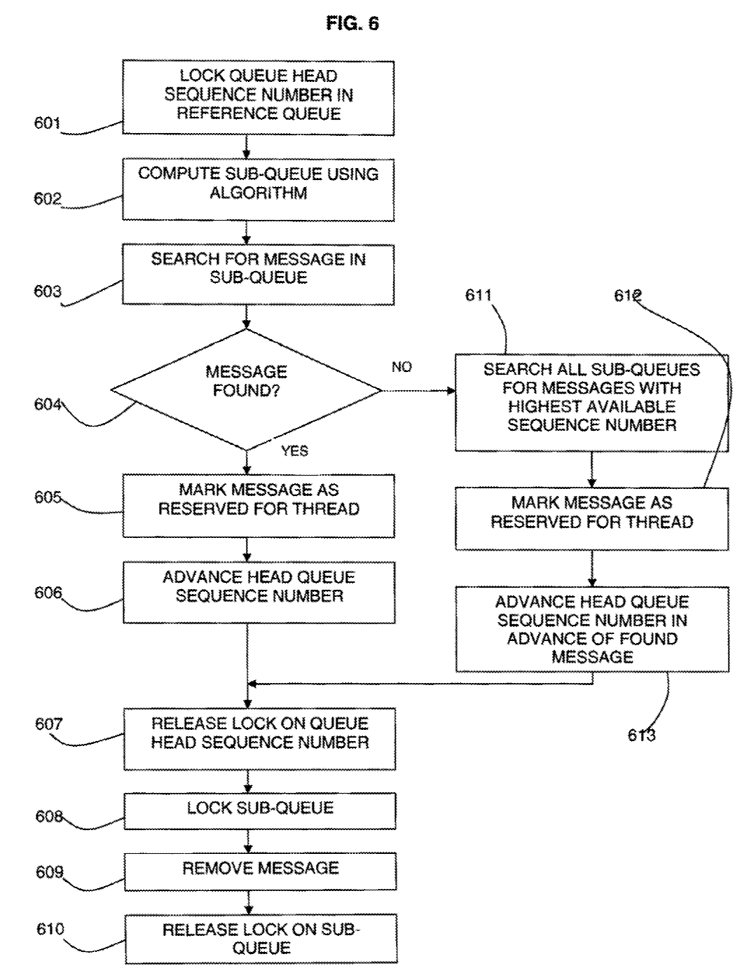

Referring to FIG. 6, a flow diagram shows the steps to remove a message at the head of the queue.

1) Lock the queue head sequence number 601 in the reference queue.

2) Compute the sub-queue using the same algorithm as above 602.

3) Search for the message to which the sequence number is assigned in the sub-queue 603.

4) Determine if the message is found 604.

5) If the message is found, mark it as reserved for this thread 605. See below for the case where the message is not found.

6) Advance the head sequence number 606.

7) Release the lock in the queue head sequence number 607 of the reference queue.

8) Lock the sub-queue 608.

9) Remove the message 609.

10) Release the lock on the sub-queue 610.

Where the message is not found in the predicted sub-queue in step 4) above, the following steps are taken.

1) Search all of the sub-queues for the message with the highest available sequence number 611, while the lock on the head sequence number is held. It is necessary to lock the tail sequence number as well to prevent additions to the overall list while the search is being made.

2) If a message is found, the message is marked as reserved for this thread 612.

3) The head sequence number is set in advance of the found message 613.

The process then continues from step 8) to lock the sub-queue 608, remove the message 609 and release the lock on the sub-queue 610.

Reasons why the predicted message might not be found include the following:

The transaction adding the message backed out rather than committing.

The transaction adding the message has not yet committed.

The message was removed by non-sequential (non-ordered) processing of the queue, for example, a get by message identifier.

Transaction backout must check to see if the head sequence number is ahead of the message sequence number and reset it if so.

The described method and system provide a list structure which can be concurrently processed by multiple threads by partitioning contention for the head and tail of the list. The list structure may be applied in a wide range of applications and is most advantageous when manipulation of the list structures is processor intensive compared to simple manipulating the in memory image of the list.

The present invention is typically implemented as a computer program product, comprising a set of program instructions for controlling a computer or similar device. These instructions can be supplied preloaded into a system or recorded on a storage medium such as a CD-ROM, or made available for downloading over a network such as the Internet or a mobile telephone network.

Improvements and modifications can be made to the foregoing without departing from the scope of the present invention.

What is claimed is:

1. An method for concurrent processing of list items by multiple control threads, comprising:
referencing items in a reference list by a sequence number;
distributing the items across a plurality of sub-lists;
locking the reference list when allocating or retrieving a sequence number for an item; and
locking a sub-list when adding or removing an item to or from the sub-list.

2. A method as claimed in claim 1, wherein locking the reference list when allocating a sequence number for an item includes locking a tail sequence number of the reference list during allocation of a sequence number to a new item.

3. A method as claimed in claim 1, wherein locking the reference list when retrieving a sequence number includes locking a head sequence number of the reference list during determination of the sub-list in which an item is held and during searching for the item in the sub-list.

4. A method as claimed in claim 3, wherein if the item is not found in the sub-list, searching all sub-lists for items with highest available sequence number.

5. A method as claimed in claim 1, wherein the step of distributing includes applying a distribution algorithm based on the sequence number.

6. A method as claimed in claim 5, wherein the distribution algorithm is deterministic and distributes items evenly across the sub-lists.

7. A method as claimed in claim 5, wherein determining the sub-list in which an item is held uses the distribution algorithm.

8. A method as claimed in claim 5, wherein the distribution algorithm is a round robin distribution across the sub-lists.

9. A system for concurrent processing of list items by multiple control threads, comprising:
multiple control threads contending for processing of items; and
a list structure including:
a reference list referencing items by a sequence number;
a plurality of sub-lists across which the items are distributed;
a lock for the reference list when allocating or retrieving a sequence number for an item; and
a lock for a sub-list when a control thread adds or removes an item to or from the sub-list.

10. A system as claimed in claim 9, wherein the lock for the reference list when allocating a sequence number for an item includes a lock for a tail sequence number of the reference list during allocation of a sequence number to a new item.

11. A system as claimed in claim 9, wherein the lock for the reference list when retrieving a sequence number includes a lock for a head sequence number of the reference list during determination of the sub-list in which an item is held and during searching for the item in the sub-list.

12. A system as claimed in claim 11, wherein if the item is not found in the sub-list, all sub-lists are searched for items with highest available sequence number.

13. A system as claimed in claim 9, wherein the system includes means for applying a distribution algorithm based on the sequence number to distribute the items across the sub-lists.

14. A system as claimed in claim 13, including means for determining the sub-list in which an item is held using the distribution algorithm.

15. A system as claimed in claim 9, wherein the system is a multiprocessor system.

16. A system as claimed in claim 9, wherein the reference list and the sub-lists are queue structures.

17. A system as claimed in claim 9, wherein the system is a messaging system.

18. A system as claimed in claim 9, wherein the system is a reliable messaging system with a reference list and sub-lists in the form of queues and adding or removing an item puts or gets a message from the queues.

19. A computer program product stored on a computer readable storage medium, comprising computer readable program code for performing the steps of:
referencing items in a reference list by a sequence number;
distributing the items across a plurality of sub-lists;
locking the reference list when allocating or retrieving a sequence number for an item; and
locking a sub-list when adding or removing an item to or from the sub-list.
